(19) United States
(12) Patent Application Publication
(10) Pub. No.: US 2007/0088709 A1
(43) Pub. Date: Apr. 19, 2007

(54) System and Methods for Intergrating Data Into a Network Planning Tool

(75) Inventors: John Bailey, London (GB); Richard Baxter, Atlanta, GA (US); Andrew Codd, Hampshire (GB); Aleksander Kalezic, Newark, CA (US); Jake MacLeod, Frederick, MD (US); Vaidyanathan Ramasarma, Frederick, MD (US); Stephen Smith, Atlanta, GA (US); Glenn Torshizi, Gaithersburg, MD (US)

Correspondence Address: CRAIN, CATON & JAMES, FIVE HOUSTON CENTER, 1401 MCKINNEY, 17TH FLOOR, HOUSTON, TX, 77010, US

(73) Assignee: Bechtel Corporation, Frederick, MD (US)

(21) Appl. No.: 11/538,260

(22) Filed: Oct. 3, 2006

Related U.S. Application Data
(60) Provisional application No. 60/723,154, filed on Oct. 3, 2005.

(51) Int. Cl. G06F 17/30; G06F 7/00

(52) U.S. Cl. 707/10

(57) ABSTRACT

The system and methods of the present invention relate to integrating real or simulated data into a network planning tool.

### CROSS-REFERENCE TO RELATED APPLICATIONS

The priority of U.S. Provisional Patent Application No. 60/723,154, filed on Oct. 3, 2005, is hereby claimed, and the specification thereof incorporated herein by reference.

### STATEMENT REGARDING FEDERALLY SPONSORED RESEARCH

Not applicable.

### FIELD OF THE INVENTION

The present invention generally relates to a system and methods for integrating real and/or simulated data into a network-planning tool sometimes referred to as a virtual survey tool or VST.

### BACKGROUND OF THE INVENTION

In traditional deployments, network planning and site acquisition activities are treated as two distinct functions. Identifying them as physically separate activities reduces work process efficiency. In this traditional process, preliminary network planning precedes the mobilization of the deployment team. Preliminary network planning is based on desktop designs that use available propagation data and a list of theoretically suitable sites. Site acquisition teams then attempt to locate candidate sites within the search area and obtain approval before proceeding. This process is typically repeated several times before a suitable candidate is identified. From a quality and site number standpoint, the end product is often a sub-optimal design due to prohibitive financial and time requirements associated with multiple mobilizations of site acquisition teams. The ability to conduct virtual site visits decreases such costs by merging candidate identification and preliminary site selection.

The problem of multiple mobilizations of site acquisition teams has been addressed using software within the realm of network planning and site acquisition for networks designed specifically to cover rail systems. Network planning for rail systems caters specifically to linear pathways utilizing a rail network coordinate system due to the nature of the rail system. The linear nature of past rail projects have limited the scope and usability of the software within an urban environment due to an inability, among other things, to utilize a common coordinates referencing system or conduct line of sight analysis. Further, prior rail based systems have limited application in urban environments due to an inability, among other things, to model and visually characterize urban land use, to “fly-around” 3D structures, or conduct virtual road tours.

### SUMMARY OF THE INVENTION

The present invention meets the above needs and overcomes one or more deficiencies in the prior art by providing a system and methods for integrating data into a network planning tool.

In one aspect of the present invention, a system is provided for integrating data into a network planning tool that is embodied on one or more computer readable media and is executable on a computer. The system includes an operator interface for accepting the data; a profile viewer module for generating a profile view of at least a portion of the data; a virtual reality module for generating a model of at least a portion of the data; a video viewer module for generating a video view of at least a portion of the data; a map viewer module for generating a 2D map of at least a portion of the data; and a data interface for integrating the profile view, the model, the video view and the 2D map into a single display.

### BRIEF DESCRIPTION OF THE DRAWINGS

The present invention is described in detail below with reference to the attached drawing figures, wherein like elements are referenced with like reference numerals, and in which:

FIG. 1 illustrates the 2D map viewer of the present invention;

FIG. 2 illustrates the video viewer of the present invention;

FIG. 3 illustrates the virtual reality model of the present invention;

FIG. 4 illustrates the profile viewer of the present invention;

FIG. 5 illustrates an integrated display of FIGS. 1-4; and

FIG. 6 is a block diagram illustrating a system that may be used to implement methods of the present the invention.

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other present or future technologies. Moreover, although the term “step” may be used herein to describe different elements of methods employed, the term should not be interpreted as implying any particular order among or between various steps herein disclosed or claimed unless otherwise expressly limited by the description to a particular order.

An integrated process of candidate identification and preliminary site selection merges the intelligence from the site acquisition teams into the network planning process (site-refining process). An integrated network planing approach using a virtual survey tool reduces deployment costs by integrating the network planning and site acquisition teams to quickly and cost effectively optimize accurate site selection decisions from a desktop environment. The integrated network planning approach therefore merges the two teams and utilizes the VST to optimize the site selection process, thus enabling significant schedule savings.

Initial site visits to assess site viability may be carried out from a desktop using the VST. As illustrated below, merging candidate identification and preliminary site selection result in a far more efficient process than the one employed by the traditional process. The benefits in utilizing the VST are highly desirable in deployments of 3GSM (third-generation Global System for Mobile Communications) systems such as UMTS (Universal Mobile Telecommunications System)/WCDMA (Wideband Code Division Multiple Access), since coverage overlap is a major source of interference. The benefits include increased probability of successful site selection; simplified site acquisition process; enhanced design quality; lower design job-hours; reduced site visits; accelerated deployment schedule; and lower network deployment costs. As set forth below, embodiments of the invention propose a general method to determine appropriate cell site positions. As will be explained in further detail, attributes of a potential cell site can be evaluated utilizing the present invention. The attributes potentially evaluated will be farther explained below and can also be used to determine the preferred location of a cell site. The VST can equally be applied to other projects such as wireless networks and wireline projects.

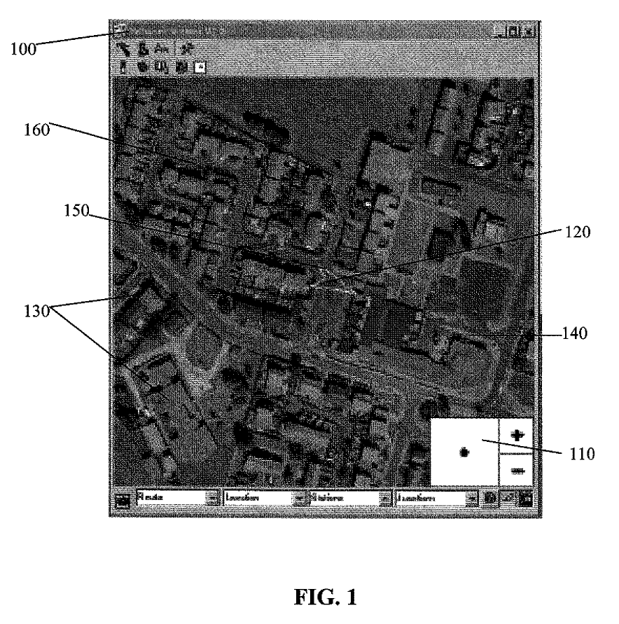

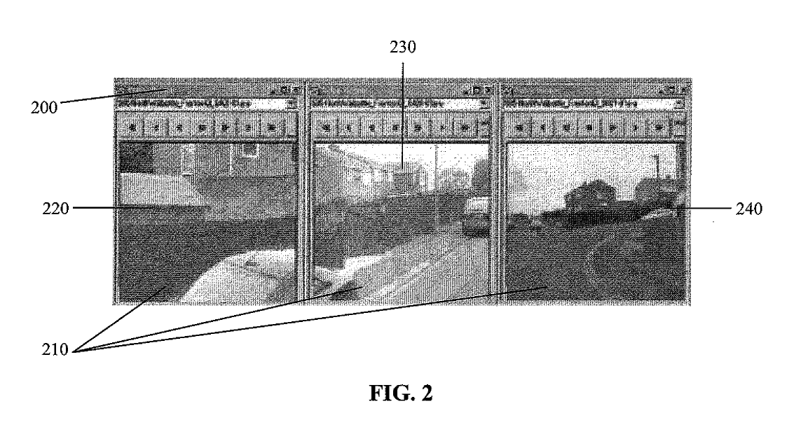

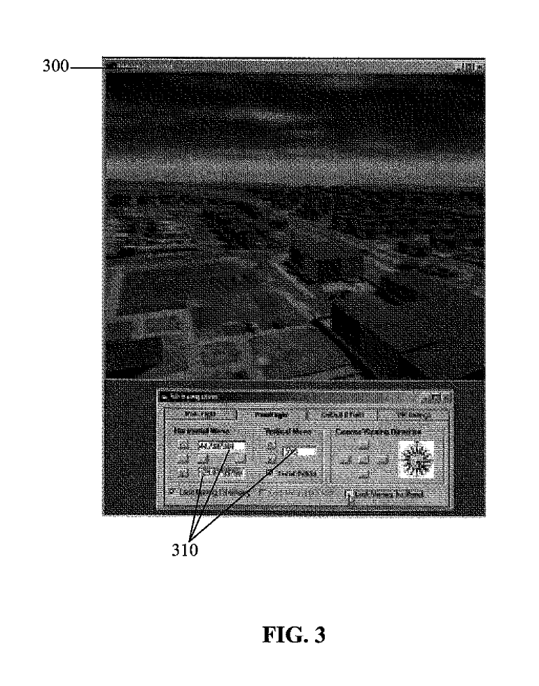

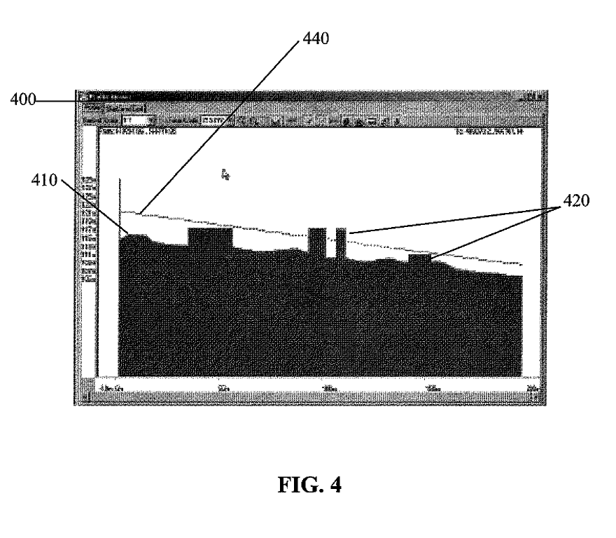

As illustrated in FIG. 1, the VST integrates or merges data from a variety of sources such as, for example, digital terrain maps (DTMs), aerial photography and video in order to aid in the design process. In FIG. 1, a 2D map viewer 100 merges aerial photography with an asset overlay. An asset management tool enables color-coding of the structures (assets) illustrated in the 2D map viewer 100. In FIG. 2, a video viewer 200 provides real time footage at multiple angles. In FIG. 3, a virtual reality model 300 drapes an aerial view over a digital terrain model to generate a fully interactive 3D representation of the desired area. In FIG. 4, a profile viewer 400 enables the comparison of a profile (e.g. height) between two separate points such as, for example, a building and a tower. Assets such as, for example, buildings illustrated in the profile viewer 400 may be selectively hidden from view and a prospective site may be selected for a structure such as, for example, a tower wherein the structure's height may be adjusted for purposes of planning a network based on predetermined criteria.

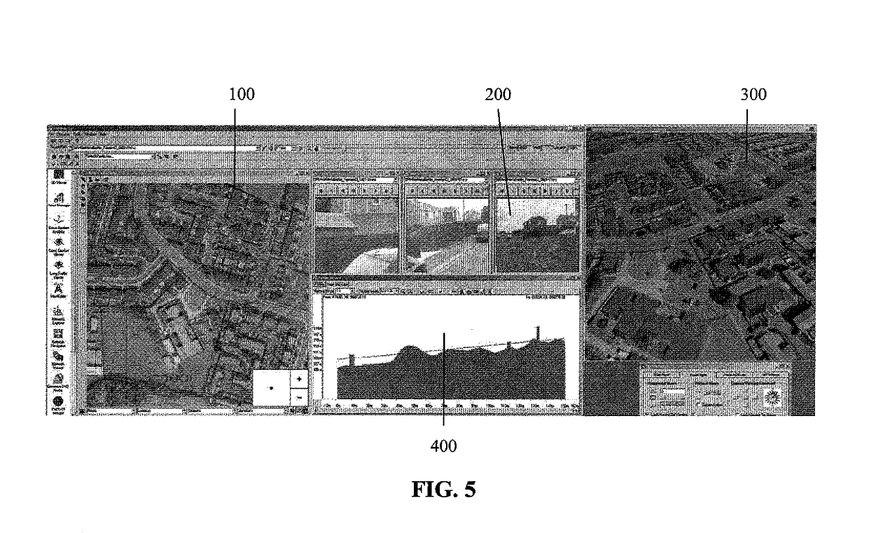

The integrated display illustrated in FIG. 5 may have particular utility in the selection and deployment of a wireless network of cell phone towers. The 2D map viewer 100, video viewer 200, virtual reality model 300 and profile viewer 400 have been used to display the physical characteristics of an area for use in the cell site position selection process. The 2D map viewer 100 can display aerial photography of a selected area. The video viewer 200 can display video footage taken during a video recorded survey of a specified route within an area. The virtual reality model 300 can display aerial photography draped over a digital terrain model to give a filly interactive 3D representation of an area. The profile viewer 400 can display a cross-sectional analysis of an area against both the digital terrain 410 and digital surface models 420. The 2D map viewer 100, video viewer 200, virtual reality model 300 and profile viewer 400 are synchronized in real time for optimal interactive use in the site selection and network planning process. As a result, the VST provides the following capabilities:
i) Montaging “fly-around” 3D structures that can be viewed from any location;
ii) Linking with an existing site database of 3D models and land usage cartography;
iii) Locating the viewing angle for a virtual tour at any height for line-of-sight analysis;
iv) Providing a virtual road tour of the proposed location with multiple camera angles; and
v) High-resolution measurement of any object or structure in the display window.

The integrated display illustrated in FIG. 5 may also be applied to other wireline network planning efforts such as, for example, the selection and deployment of fiber optic cable. Other applications of the VST to wireless and wireline network planning efforts may be obvious to those skilled in the art, and the embodiments described herein are not intended to limit the application of thereof.

Referring generally to FIGS. 1-5, the present invention allows the user to simultaneously display asset data on a 2D map viewer 100, a video viewer 200, a virtual reality model 300 and/or a profile viewer 400. The asset data displayed may include point data (for example cell sites), vector data (for example buildings), imagery (for example aerial photography, satellite imagery or coverage diagrams), DTMs (for example bald earth or clutter surfaces), and IBI video data, Loading and displaying of mapping and aerial data is interrupted by any navigation event, allowing simultaneous display of asset data.

The user can input asset data through the asset management tool, discussed in detail below. Data required to support a “market” can be registered against the MDE (managed data environment). Any data registered against the MDE can be assigned a unique display name that may be referred to throughout the system. Anytime an asset attribute is added or modified during a project, the MDE is also updated. Consequently, the project and MDE must share meta data about the same assets. Asset data may follow a data scheme or format that allows interface between the invention and other systems.

Registered point data can represent, for example, a 3D point where the elevation is determined from a nominated data attribute, or a 3D point where the elevation of the point is determined from the DTM and an optional user defined vertical offset.

Registered vector data can represent, for example, a 3D “roofed” object, where the roof elevation is determined from a nominated data attribute; a 3D “roofed” object, where the roof elevation is determined from the DTM and a user defined height; a “closed” 3D fence (boundary), where the vector is assigned an elevation from the DTM and a user defined height; or an “open” 3D fence where the vector is assigned an elevation from the DTM and a user defined height.

Captured video data may be registered against the MDE. Such video data is automatically detected from all “exposed” hard drives and listed for registration. Video routes may be selected from a list and prevented from being registered into the MDE. Full visibility of the progress of video data registration is provided to the administrator, including notification and identification of video registration failures. Video data may be processed into a smooth “shape” representing the traveled path of the video capture vehicle. Such “smoothed” video is registered against the MDE with deference to the “raw” GPS coordinates.

Project data may be published from data registered against the MDE. The scope of a project can be controlled by data type and project centroid (coordinate), for example, selected point asset types within a nominated tolerance of the project's centroid; selected vector asset types within a nominated tolerance of the project's centroid; selected imagery within a nominated tolerance of the project's centroid; selected DTMs within a nominated tolerance of the project's centroid; or video routes within a nominated tolerance of the project's centroid.

A link between a document in a document management system and any registered asset may be established. Any link established with documentation must also persist in the MDE in the same way as other meta data. This link may be implemented through, for example, a web or Windows interface depending on the system available. The current version of a requested document may be queried from the document management system by the user and displayed in its associated application (for example if a Microsoft Word document is returned, it is presented in Word).

The 2D map viewer 100 can be utilized to display aerial photography of a selected area. The 2D map viewer 100 can be zoomed in and out by the user. Zooming can occur between, for example, a regional and local display utilizing a user-controlled navigation panel 110, which may be displayed on-screen.

An icon, for example a cross 120, may indicate the current active location of display on the 2D map viewer 100. The 2D map viewer 100 can display a grid over the viewer. The grid color and grid interval may be configured as needed. The grid interval may be zoom depth sensitive.

Building assets and other structures can be overlaid onto the 2D map displayed in the 2D map viewer 100. Each 2D overlay 130, representing the dimensions of a building or structure, can be stored by the user in a fully configurable database linked to the present invention.

An asset manager utility provides a user interface into the database in which the 2D overlays are stored. This interface allows the user to insert, update and view all data relating to any given asset. Any number of asset types, including but not limited to, boundary-assets and telecom masts, can be registered in the database.

Asset characteristics can be identified and assets color-coded on the 2D map viewer to allow visual representation of the particular characteristics of each asset. Asset characteristics displayed in this manner can include, but are not limited to, building height or building uses such as commercial, industrial or residential.

A navigation panel 110 on the 2D map viewer 100 can be utilized to survey the 2D map to evaluate asset characteristics in any particular map area that have been color-coded to indicate specific asset characteristics. For example, specific colors could be assigned to buildings within specific ranges of height, allowing the 2D survey to be utilized, for example, to select taller buildings that could be utilized to shield the mast site from visually sensitive surrounding areas.

The user can select and place a mast on a selected site on the area map by selecting a mast from a database of pre-defined masts. The mast site can be changed by the user at a later time as necessary. Such a potential mast placement can then be identified on the 2D map viewer 100 by the location of a user-defined icon, for example a cross 140. The X, Y and Z coordinates associated with this potential placement can be displayed on the 2D map viewer 100.

The 2D map viewer can be synchronized with an online map service (for example: Google Maps®). This synchronization may occur either in a dynamic or non-dynamic fashion. Specific locations (for example: addresses, zip codes and points of interest) may be searched within the map service and not only be displayed by the online map service, but the location may also be synchronized on the 2D map viewer 100. Point assets including cell sites and vector assets including video routes can be superimposed as flags or poly-lines on online service maps to provide an extremely simple interface.

The video viewer 200 can be used to display video footage taken during a video recorded survey of a specified route. The active location from which the video has been taken can be indicated simultaneously on the 2D map viewer 100. This feature demonstrates a key component of the invention, which is that all of the data is spatially registered against a common coordinate system, allowing all views to be fully synchronized during display. The video viewer 200 can simultaneously display video footage 210 from multiple synchronized views of the active location corresponding to different angles of sight from the active location including, but not limited to, front-left 220, straight-ahead 230 and front-right 240 lines of sight. The user may access a list of routes for which video footage is available. The video segment and location within the video segment is automatically set to the current active location.

The virtual reality model 300 can be utilized to show aerial photography draped over a digital terrain model to give a fully interactive 3D representation of the area being surveyed. Such a display on the virtual reality model 300 can include a model of a potential mast at a previously selected potential mast location. The virtual reality model 300 can display “fly-around” 3D structures that can be viewed from any location. Such a virtual reality display can be created by linking with an existing site database of 3D models and land usage cartography. The virtual reality model 300 can display the current X, Y and Z coordinates 310 of the current active location. Such coordinates can be adjusted by user-controls that may be displayed on-screen. 3D data can be optionally appended to the virtual reality scene rather than discarding the current scene and recreating it at the new location.

The virtual reality model 300 is synchronized with the active location, which may be displayed on the 2D map viewer 100, allowing the user to select to see multiple views of the same active location simultaneously. Such a display on the 2D map viewer 100 can indicate the angle of the virtual reality display through the use of a user-defined icon such as an arrow 150. The virtual reality model 300 can follow a defined route about the area according to user input, including, but not limited to, the speed of travel of the active location, the vertical height of the active location above the ground and the viewing angle of the display from the active location. Such a route can be displayed on the 2D map viewer 100 as a line depicting a defined route 160.

The user can utilize the virtual reality model to survey the area surrounding a proposed mast and mark locations from which to later evaluate the visibility and appearance of the proposed mast. Such a virtual reality survey could simultaneously display the active location on both the virtual reality model 300 and the 2D viewer 100.

The virtual reality model 300 can follow a route for which video footage has been collected. Following a route for which video footage has been collected allows the user to simultaneously view the active location on the virtual reality model 300, the 2D viewer 100 and the video viewer 200.

The virtual reality model 300 can be set to follow a route though the map while maintaining a viewing angle such that the location of a potential mast cite remains in the center of the screen, allowing a determination of the visibility of a mast from a location at a user selected height along the active location's route.

The virtual reality model 300 can be instructed by the user, for example from the 2D map viewer 100 or the profile viewer 400, to zoom to a user-defined standard orientation from the selected point. For example, the user could set the standard orientation to 100 meters south of the asset and looking down at 15 degrees.

3D virtual models can be made available over the Internet.

The profile viewer 400 allows a user to conduct a cross-sectional analysis against both the digital terrain 410 and digital surface models 420. Any asset can be identified to either be evaluated or not be evaluated in a profile view. Such a tool allows the user to, for example, view a side profile including depictions of terrain, buildings and the line of sight between two selected points in the area. Such points may be selected from the 2D map viewer 100 and the profile being viewed is displayed as a line on the 2D map viewer 100. The profile viewer 400 can be utilized to determine the visibility of a mast from a particular point in the area. The proposed mast height can then be dynamically adjusted by the user to determine the mast height at which the mast can no longer be seen from a specific location. In determining visibility, the line of sight between two points can be represented by a straight line 440 on the profile viewer 400, with the line appearing in a designated color if the line of sight is obstructed and a different color if the line of sight is unobstructed.

The profile viewer 400 can be used to reverse engineer a new line of sight between designated points such that an unobstructed view is available from a designated point to, in example, the top of a proposed cell tower. The new line of sight can be displayed in a color different from the colors used to indicate an obstructed or unobstructed line of sight. The height at the end of the line of sight from the designated point can be calculated and displayed. A maximum vertical offset above the end of the line of sight may be defined as a constraint for the reverse engineered line of sight.

The profile viewer 400 is utilized to view the profile between a designated point and a different point located at a designated distance, height and angle from the designated point. A 360-degree collection of profile views can be collected with each profile representing a nominated radial increment. Each profile can be designated as either an obstructed or unobstructed view between the designated point and the different point. The 2D map viewer 100 can be utilized to display a 360-degree display of lines of sight from the designated point, with lines of sight displayed in a designated color if the line of sight is obstructed and a different color if the line of sight is unobstructed. Any particular line of sight can be selected on the 2D map viewer 100 and displayed on the profile viewer 400. Profiles generated during a 360-degree analysis can be cached in order to allow their redisplay without reanalysis. Further, the current profile analysis can be reset and all fields emptied in readiness for a new analysis.

Still referring to FIGS. 1-5, the initial step in positioning a cell site using the present invention is selection of potential generalized locations where permission to build a site is more likely to be obtained. Cell sites are more likely to be acceptable within a commercial area. To this end, the user can display the area on the 2D map viewer 100 and, using the asset management tool, choose to change the colors of building assets according to building types stored in the database. Specifically, the user can display building use (IE commercial, residential, hospital or industrial) by building color. The user can then move about the area using the navigation panel 110 located on the 2D map viewer 100 and select potential generalized locations for cell site location by locating areas of exclusive or predominate commercial use.

After selecting a generalized location for a potential site in a predominately or exclusive commercial area, the next step is to look over the surrounding area and take note of any locations nearby that may require visual shielding from a cell site, for example schools, homes or hospitals. After making such an evaluation, the user may again use the asset management tool to change the colors of building assets. This time, the user may color-code the building assets according to building height. The user may then scan the area between the generalized potential cell location and any visually sensitive buildings in the area to determine which buildings are tall enough to potentially yield visual shielding between the visually sensitive areas and the cell site. Such visual shielding may help the user to obtain permission to build a mast in a particular location.

A user may then select to activate the video viewer 200, which can be used to display video footage taken during a video recorded survey around the area. Such video footage can be selected from previously recorded video surveys of a designated route, or the user could request a new survey be taken and footage of a new route uploaded. The user can play the video footage on the video viewer 200 and trace the progress of the video by watching the cross 120, representing the active location, move along the line depicting the defined route 160 on the 2D map viewer 100. Viewing video footage of an area surrounding a potential cell location allows the user to enhance the accuracy of all design assumptions.

At this point, the user may determine a specific potential cell site by locating a position within the generalized potential cell location that appears to have visual shielding from all visually sensitive locations. The user can now select the necessary mast from a selection of predefined masts in the database and place the potential mast on the proposed location within the 2D map viewer 100. The location will appear as a cross 140 on the 2D map viewer 100.

The user may then activate the virtual reality model 300 to access a fully interactive 3D representation of the area being surveyed. The user may view the area and note potential benefits or problems of the potential mast location by evaluating the area using the virtual reality model 300. The active location and angle of the virtual reality model 300 is identified on the 2D map viewer 100 as arrow 150. The user can evaluate visibility of a proposed mast at street-level by having the virtual reality model 300 travel in a user defined path while maintaining an angle of vision towards the proposed mast looking from street-level. The user may further select to evaluate the area by having the virtual reality model 300 scan the location, for example, via free flight path towards the location at a designated height; travel along a predefined route for which video footage may be simultaneously displayed; or flight around the proposed mast in a circle at a designated height and constant radius while maintaining view of the potential mast.

A user may further evaluate visibility of a proposed cell site from visually sensitive locations by activating the profile viewer 400. The profile viewer 400 can be utilized to view a side profile including depictions of terrain, buildings and the line of sight between the visually sensitive location and the proposed cell cite. The line of sight from the visually sensitive location may be displayed on the profile viewer 400 and will indicate if the proposed mast is visible from this location. If the mast is visible from a visually sensitive location, the profile viewer 400 can be used to reverse engineer a new mast height that would render the mast not visible. The user can then determine whether the proposed new mast height is acceptable or not.

The user can, at any point in this process, choose to change potential cell site locations, evaluate the area via the display other characteristics of building assets, or utilize other features of the invention.

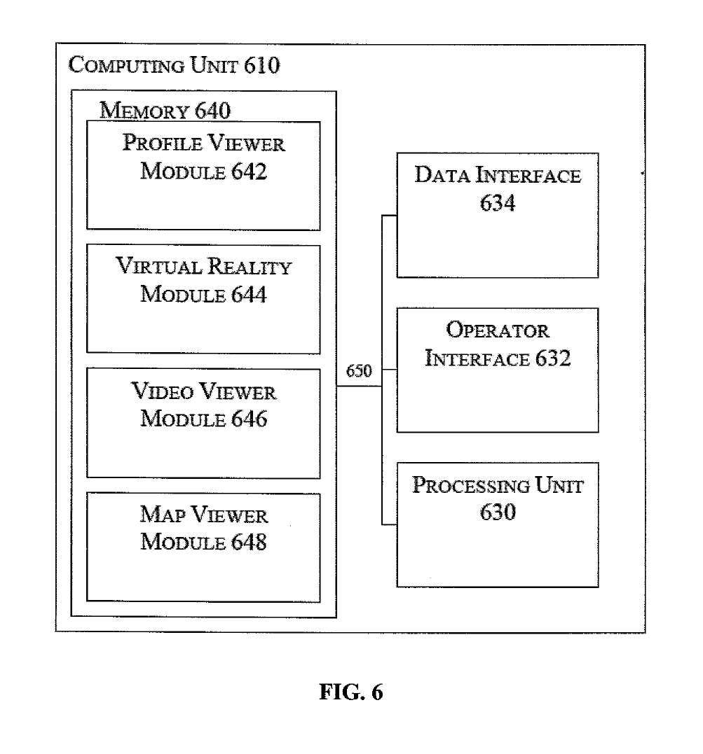

Referring now to FIG. 6, a system is illustrated that may be used to implement the methods of the present invention. A computing unit 610 may include computer components including a processing unit 630, an operator interface 632 and a data interface 634. The computing unit 610 may also include a memory 640, including a profile viewer module 642, a virtual reality module 644, a video viewer module 646 and a map viewer module 648. The computing unit 610 may further include a bus 650 that couples various system components including the system memory 640 to the processing unit 630. The computing unit 610 is only one example of a suitable computing environment and is not intended to suggest any limitation as to the scope of use or functionality of the invention.

The memory 640 preferably stores modules 642, 644, 646 and 648, which may be described as program modules containing computer-executable instructions. The profile viewer module 642, the virtual reality module 644, the video viewer module 646, and the map viewer module 648 each contain computer executable instructions necessary to generate a profile view, a model, a video view and a 2D map, respectively, of data selected by an operator. These modules 642, 644, 646 and 648 will be further described below in conjunction with various embodiments of the present invention.

Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Although the computing unit 610 is shown as having a memory 640, the computing unit 610 typically includes a variety of computer readable media. By way of example, and not limitation, computer readable media may comprise computer storage media and communication media. The memory 640 may include computer storage media in the form of volatile and/or nonvolatile memory such as a read only memory (ROM) and random access memory (RAM). A basic input/output system (BIOS), containing the basic routines that help to transfer information between elements within computing unit 610, such as during start-up, is typically stored in ROM. The RAM typically contains data and/or program modules that are immediately accessible to and/or presently being operated on by processing unit 630. By way of example, and not limitation, the computing unit 610 includes an operating system, application programs, other program modules, and program data.

The components shown in memory 640 may also be included in other removable/non-removable, volatile/nonvolatile computer storage media. For example only, a hard disk drive may read from or write to non-removable, nonvolatile magnetic media, a magnetic disk drive may read from or write to a removable, non-volatile magnetic disk, and an optical disk drive may read from or write to a removable, nonvolatile optical disk such as a CD ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media discussed above and illustrated in FIG. 6 provide storage for computer readable instructions, data structures, program modules and other data.

A user may enter commands and information into the computing unit 610 through input devices such as a keyboard and pointing device, commonly referred to as a mouse, trackball or touch pad. Input devices may include a microphone, joystick, satellite dish, scanner, or the like. These and other input devices are often connected to the processing unit 630 through the operator interface 632 that is coupled to the system bus 650, but may be connected by other interface and bus structures, such as a parallel port or a universal serial bus (USB). A monitor or other type of display device may be connected to the system bus 650 via an interface, such as a video interface. In addition to the monitor, computers may also include other peripheral output devices such as speakers and printer, which may be connected through an output peripheral interface.

In the foregoing specification, the invention has been described with reference to specific embodiments thereof and has been demonstrated as effective in providing a system and methods for practicing the present invention. However, it will be evident to those skilled in the art that various modifications and changes can be made thereto without departing from the broader spirit or scope of the invention. Accordingly, the specification is to be regarded in an illustrative rather than a restrictive sense. Therefore, the invention is not restricted to the preferred embodiments described and illustrated but covers all modifications, which may call within the scope of the appended claims.

What is claimed is:

1. A system for integrating data into a network planning tool embodied on one or more computer readable media and executable on a computer comprising:
an operator interface for accepting the data;
a profile viewer module for generating a profile view of at least a portion of the data;
a virtual reality module for generating a model of at least a portion of the data;
a video viewer module for generating a video view of at least a portion of the data;
a map viewer module for generating a 2D map of at least a portion of the data; and
a data interface for integrating the profile view, the model, the video view and the 2D map into a single display.
